(19) United States
(12) Patent Application Publication
(10) Pub. No.: US 2003/0063113 A1
(43) Pub. Date: Apr. 3, 2003

(54) Method and system for generating help information using a thesaurus

(76) Inventor: Joost Reiner Andrae, Hamburg (DE)

Correspondence Address: SONNENSCHEIN NATH & ROSENTHAL, 1301 K STREET NW, SUITE 600, EAST TOWER, WASHINGTON, DC, 20005, US

(21) Appl. No.: 10/260,577

(22) Filed: Oct. 1, 2002

(30) Foreign Application Priority Data
Oct. 2, 2001 (EP) 01 123 244.4

(51) Int. Cl. G06F 7/00

(52) U.S. Cl. 345/700

(57) ABSTRACT

A method and system for generating help information associated with a plurality of terms is provided, including receiving a request for information including a search term from a user. The search term is transmitted to a thesaurus and a list of synonyms of the search term is returned. Based on the search term and the returned list, a selection index is generated and may be presented to a user. The user may then select information elements in the selection index to obtain the desired help information. Alternatively, in a multilingual mode, a search request from the user may be transmitted to a plurality of thesauruses.

### CROSS REFERENCE TO RELATED APPLICATION

This application is related to, and claims priority to, European Patent Application No. 01 123 244.4, filed on Oct. 2, 2001, commonly owned, and entitled “Information Service Unit Using a Thesaurus,” and which is hereby incorporated by reference herein in its entirety.

### BACKGROUND

1. Field of the Invention

The present invention relates to providing help information in a data processing system. In particular, this invention relates to an improved method and system for providing help information in a data processing system using a thesaurus.

2. Background Information

Data processing devices are used for a wide range of versatile applications, providing services to potentially large numbers of different users. The applications may range from editing of text documents or spreadsheet applications to complex software systems, for example, for computer aided design and manufacturing, purchasing, computer aided banking applications, entertainment applications, and numerous other application areas. Increasingly complex software applications are employed in the field of personal services, for example, for personal data organization and mobile communication applications such as mobile telephones or communications services and other services provided over computer networks, such as the Internet.

In any of the above examples, users not fully acquainted with the software application may not be able to use the entire range of services provided by the application. Further, during execution of the application, problems or faults may occur, example, when accessing data, while printing, while storing data, or when performing similar activities. Thus, specialized help applications have been developed to provide a user with information necessary for control or troubleshooting.

Systems exist which provide generalized information. These systems may be adapted to present information on a particular subject to a user, for example, over a computer network such as the Internet. Exemplary systems include knowledge bases and the World Wide Web.

An exemplary related art help application is shown in FIGS. 1a-1c. For this example, a user desires help with a term for which the user is unfamiliar. The user request help from the help application by providing the term and receiving a selection index in response from the help application. The user may then select an information element from the selection index to retrieve further information to satisfy the user's request for help.

A term 100 of FIG. 1a is received by a help application 102, which generates a selection index 104 that includes a list of information elements, e.g., terms, associated with the term 100. As a more specific example, the term 100 of FIG. 1b having a value of “squib” is received by the help application 102, which generates the selection index having information elements, or entries having a value of “null response,” meaning that the help application was unable to locate any information elements relevant to the search term having a value of “squib.”

As another example, the term 100 of FIG. 1c having a value of “paragraph” is received by the help application 102, which generates the selection index having information elements, or entries for values of “numbering bullets,” “double line,” “default,” “tabulator,” “anchoring,” and “indent spacing.” The user may submit a value for term 100 and receive the resulting selection index, which may then be used to determine an appropriate response to the user's needs. The selection index 104 of this example includes information elements which include references to help information which may satisfy the user's request for help. For example, the user may select one of the information elements of the selection index 104 to obtain more information related to the selected element.

Applications such as those discussed above are increasingly available to users in different regions of the world, the users potentially speaking different languages. Systems exist for building and searching indexes in a plurality of different languages. However, a search request generated by a particular user may specify a term in a particular language related to desired information, but if information elements maintained by the application are not maintained in this particular language, the search request may not always result in an identification of appropriate applicable information elements. For example, a keyword search performed based on a search term in the German language may not result in an identification of a corresponding information element in the English language. Even if the help application maintains information elements in the same language as a term in the search request specifying desired information, the term may be too specific to be linked with all information elements having content which is related to the desired information.

Therefore, a need has long existed for a method and system that overcome the problems noted above and others previously experienced.

### SUMMARY OF THE INVENTION

Methods and systems consistent with the present invention provide an improved method and system for obtaining help, using a thesaurus to enhance a search request by adding synonyms of the search term to the search request, and generating a selection index having an enhanced, or increased number of information elements associated with desired information by sending the enhanced search request to a help application. Thus, a potentially broader selection index is generated to satisfy a particular request.

In a multilingual environment, a plurality of thesauruses in different languages or dialects may be used to enhance the search request, and to generate a broader selection index to satisfy the request.

According to an exemplary embodiment, a method in a data processing system having a help system with search terms and corresponding items of information includes the steps of receiving a request for information about a topic, the request containing one of the search terms; identifying other search terms that are related to the topic and that are not identical to the one search term; searching for items of information corresponding to the one search term and the other search terms; and returning the items of information. As an exemplary result, a search request from a user may be enhanced to obtain a larger selection index based on the search request from the user. In this manner, the selection index may include more terms, keywords, or synonyms related to the information request.

The method may further include a step of selecting a thesaurus. Additionally, a thesaurus may be selected based on an indicator of a language. The thesaurus may be used to identify the other search terms that are related to the topic and that are not identical to the one search term.

Alternatively, instead of a thesaurus, a database having one-to-many relationships among a plurality of terms (i.e., a single term may be associated with a plurality of other terms), may be used to identify the other search terms that are related to the topic. Using a thesaurus enables use of existing resources of a computerized application. For example, a text processing system may already include a thesaurus in different languages including language dialects, which can be utilized by a preprocessor to a help application. Further, this example enables accounting for a user language of a search term of the search request by selecting one of different thesauruses in different languages based on a language indicator of the user language.

The help system may include a help application, and the selection index may include information elements or help topics from which a user may select. Thus, the selection index may include information elements or a list of offered help topics related to a received search request, the selection index including a larger number of offered information elements or help topics than would be included without using the thesaurus.

In this example, the selection index may be generated by a preprocessor to a help application (or by the help application) by performing a keyword search of the help application based on the list of other terms (e.g., synonyms) and the search term. Thus, instead of performing a keyword search based solely on the search term provided with the search request, the keyword search is based on all entries of the list of other terms retrieved from a thesaurus and the search term of the search request.

A language indicator, which may be-included in the request for information, may specify a preferred language of a user including a language dialect. A thesaurus may be used for identifying the other search terms, and the thesaurus may include a plurality of terms in a language corresponding to the preferred language. The method may further include a step of selecting a first thesaurus. The step of selecting may include selecting at least one second thesaurus which includes a plurality of terms in a language different from the preferred language, and the request from the user may be transmitted to the first and at least one second thesaurus. Accordingly, in addition to generating a selection index based on a single thesaurus corresponding to a user language, thesauruses in further languages may be used to service a user request, thus potentially increasing the number of information elements returned with the selection index.

The language indicator may be derived from a user profile or a user may be prompted to input an indicator of the user language by specifying a list of indicators of at least one preferred language. Thus, the language indicator may either be obtained automatically, or the user may be enabled to input information regarding preferred languages. For example, the user could input information regarding a single language for generating the selection index or information regarding multiple languages, in which case thesauruses in a plurality of languages may be used for generating the selection index.

Additionally, a preliminary, or initial, index may be generated based on the search term, the initial or preliminary index including at least one term related to the topic, and a request associated with the initial or preliminary index may be used to identify the other terms. Thus, the number of elements of the selection index may increase, as the original search request is enhanced by generating the initial or preliminary index, which is then transmitted to the thesaurus.

The selection index and the initial or preliminary index may be generated using a common method. Thus, the number of information elements generated for the selection index can be increased without additional system requirements.

The help system may include a plurality of language specific index tables for generating the selection index, and generation of the initial or preliminary index may include selecting a first thesaurus in a language specified by a language indicator (e.g., obtained from a user). Further, the initial or preliminary index may be generated by additionally selecting at least one second index table in a language different from the language specified by the language indicator, thus potentially increasing the size of the selection index.

The preprocessor for the help application may reside on a server system, and the request for information may be received over a communication link from a client unit. Further, the selection index may be transmitted to the client unit. Accordingly, the method for providing information may be implemented on a distributed system, communicating either via dedicated communication links or over computer networks.

The selection index may include links to storage locations storing the requested information. Thus, the selection index may include identifiers of information elements including the requested information which can then be selected by a user when needed.

A program consistent with the present invention may include instructions for carrying out the method discussed above. Further, a computer-readable medium consistent with the present invention may include a program to cause a data processing system to execute the method discussed above. Additionally, a computer program product may include the computer-readable medium. As a further example, a data processing system for obtaining items of information corresponding to search terms, may include at least one CPU, a help application, and a memory encoded with instructions to cause the at least one CPU to perform the steps of receiving, from a user, a request for information about a topic, the request containing one of the search terms, identifying other search terms that are related to the topic and that are not identical to the one search term, searching for items of information corresponding to the one search term and the other search terms, and sending the items of information to the user.

Further, a data processing system for obtaining items of information corresponding to search terms may include a memory comprising a help system that receives a request for information about a topic, the request containing one of the search terms, identifies other search terms that are related to the topic and that are not identical to the one search term, searches for items of information corresponding to the one search term and the other search terms, and returns the items of information to the user; and a processor for running the help system.

Other apparatus, methods, features and advantages consistent with the present invention will be, or will become, apparent to one with skill in the art upon examination of the following figures and detailed description. It is intended that all such additional systems, methods, features and advantages be included within this description, be within the scope of the present invention, and be protected by the accompanying claims.

### BRIEF DESCRIPTION OF THE DRAWINGS

FIGS. 1a-1c depict a block diagram of a related art help system.

FIGS. 2a-2b depict a block diagram of an exemplary help system suitable for practicing methods and implementing systems consistent with the present invention.

FIG. 3 depicts a block diagram of an exemplary computer system suitable for practicing methods and implementing systems consistent with the present invention.

FIG. 4 depicts a flowchart of the steps performed by a help system according to an exemplary embodiment consistent with the present invention.

FIG. 5 depicts a flowchart of the steps performed by a help preprocessor for providing an information service according to an exemplary embodiment consistent with the present invention.

FIG. 6 depicts a flowchart of the steps performed by a module for sending a request to a thesaurus according to an exemplary embodiment consistent with the present invention.

FIG. 7 depicts a block diagram of an exemplary system for providing an information service illustrating joint use of thesauruses by an application and a help system.

FIG. 8 depicts a flowchart of the steps performed by a system for providing help information according to an exemplary embodiment consistent with the present invention.

### DETAILED DESCRIPTION

Methods and systems consistent with the present invention provide an improved method and system for obtaining help, using a thesaurus to enhance a search request by adding synonyms of the search term to the search request, and generating a selection index typically having an enhanced, or increased number of information elements associated with desired information, by sending the enhanced search request to a help application. Thus, a potentially broader selection index is generated to satisfy a particular request.

In a multilingual environment, a plurality of thesauruses in different languages or dialects may be used to enhance the search request, and to generate a broader selection index to satisfy the request.

Reference will now be made in detail to an implementation in accordance with methods, systems and articles of manufacture consistent with the present invention as illustrated in the accompanying drawings. The same reference numerals may be used throughout the drawings and the following description to refer to the same or like parts.

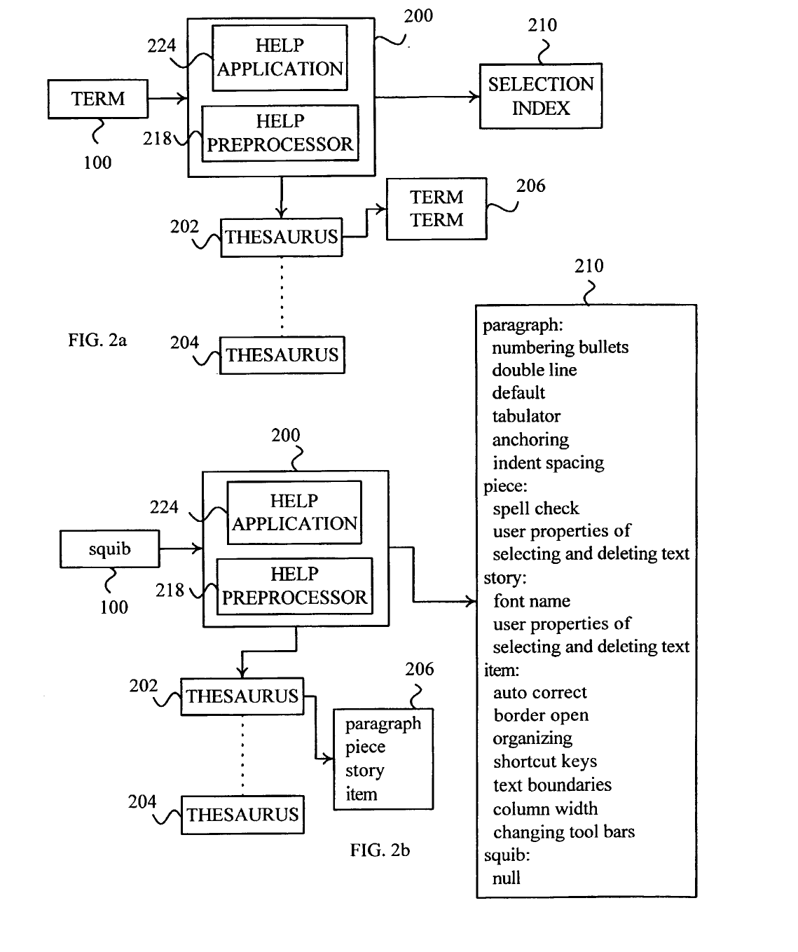

FIGS. 2a-2b depict a block diagram of an exemplary help system suitable for practicing methods and implementing systems consistent with the present invention. A term, or character string 100 of FIG. 2a is transferred to a help system 200. The help system 200 includes a help preprocessor 218 and a help application 224. The term 100 may be sent, for example, by a user or an agent of a user, or any type of entity that requests help information (e.g., by requesting a selection index). In this context, a selection index may include a list of terms, or information elements.

The help preprocessor 218 transmits an indicator of the term 100 to a thesaurus 202, which determines a list of terms or search index 206 which are synonyms of the term 100, and transmits an indicator of the list 206 to the preprocessor 218. Alternatively, instead of using the thesaurus 202, the preprocessor 218 may transmit the indicator of the term 100 to a database of indicators of one-to-many relationships among terms, and the list 206 may include a list of the terms related to term 100 which are included in the database. The help application 224 determines information elements and generates a selection index 210 based on the list 206 received from the thesaurus 202. A thesaurus 204 may also be used for generating a list of synonyms in a different language from the list 206 determined by the thesaurus 202. In this case, a plurality of thesauruses or databases of related terms 202 an 204 may be maintained in different languages and/or dialects.

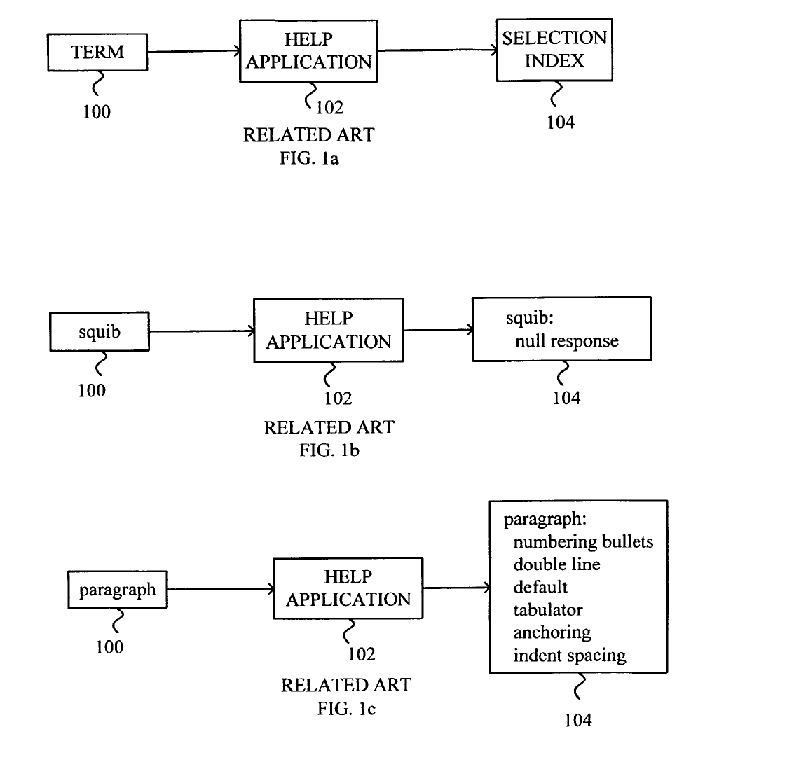

As a more specific example, the term 100 of FIG. 2b having a value of “squib” is transferred to the help preprocessor 218, which sends a request including an indicator of the term 100 to the thesaurus 202. For this example, the thesaurus 202 generates the list 206 which includes indicators of the terms “paragraph,” “piece,” “story,” and “item.” This list may be sent by the help preprocessor 218 to the help application 224 as a query in the form of search terms connected by Boolean OR operators. The help application 224 generates a selection index 210 based on the list 206 received from the thesaurus 202, and in this example, the help system 200 generates a selection index having information elements, or entries, for “paragraph,” “numbering bullets,” “double line,” “default,” “tabulator,” “anchoring,” and “indent spacing;” for “piece,” “spell check,” “user properties of,” and “selecting and deleting text;” for “story,” “font name,” “user properties of,” and “selecting and deleting text;” for “item,” “auto correct,” “border open,” “organizing,” “shortcut keys,” “text boundaries,” “column width,” and “changing tool bars;” and for “squib,” a null response, or no terms returned. Thus, for this example, the help system 200 generates a selection index 210 which is broader than the selection index 104 discussed previously with regard to FIG. 1b. Each one of the information elements of the selection index 210 may be selected by a user or user agent, to obtain specific information associated with the particular selected information element.

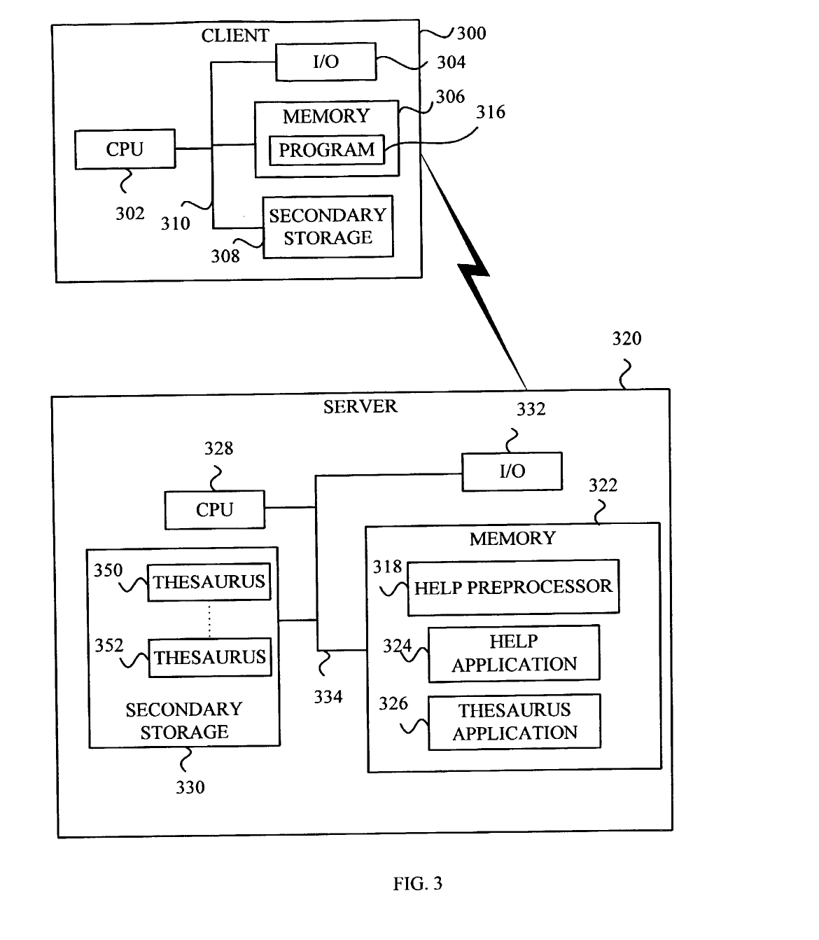

FIG. 3 depicts a block diagram of an exemplary data processing system suitable for practicing methods and implementing systems consistent with the present invention. A client 300 includes a central processing unit (CPU) 302, an input-output (I/O) unit 304, a memory 306, and a secondary storage device 308 that may communicate with each other via a bus 310. The client 300 may further include input devices such as a keyboard, a mouse or a speech processor (not shown) and a display device (not shown). The client 300 may include a human user or may include a user agent. The term “user” as used herein refers to a human user, software, hardware, or any other entity using the system.

The memory 306 includes a program 316 that includes instructions for sending the term 100 of FIGS. 2a-2c to a server 320 of FIG. 3, for receiving the selection index 210 of FIGS. 2a-2c, and for receiving information elements to satisfy the request for information associated with the term 100.

The server 320 of FIG. 3 includes a CPU 328, an input-output (I/O) unit 332, a memory 322, and a secondary storage device 330 that communicate with each other via a bus 334. The secondary storage device 330 includes a plurality of thesauruses 350 and 352. The memory 322 includes a help preprocessor 318, a help application 324 and a thesaurus application 326. The help preprocessor 318 includes instructions for receiving a request for information, including a search term, from the client 300; determining a thesaurus 350 suitable for an indicated language included with the information request; sending the request to the determined thesaurus, receiving synonyms 206 of the search term 100 from the thesaurus 350; sending the search term 100 and synonyms 206 to the help application 324; receiving items of information 210 corresponding to the synonyms and the search term 100; and sending the items of information 210 to the client 300.

The help application 324 includes instructions, for example, for receiving the search term 100 and synonyms 206 and obtaining the items of information 210 corresponding to the synonyms 206 and search term 100. The help application 324 may group the items of information into the selection index 210. If a second term or character string related to the search term is not or cannot be obtained from the thesaurus or index device, the selection index may be generated based on the search term.

An optional thesaurus application 326 includes instructions for receiving the request from the help preprocessor 318, determining the synonyms 206 and sending the synonyms 206 to the help preprocessor 318. The thesaurus application 326 communicates with the thesauruses 350 and 352 to obtain synonyms. Alternatively, the thesaurus application 326 may include one or more thesauruses or may communicate with one or more thesauruses stored in separate storage areas or storage devices. The thesaurus application 326 may include tables or a database for obtaining synonyms or related term of the search term 100. Alternatively, the help preprocessor 318 may communicate with a the plurality of thesauruses 350 and 352 to obtain the synonyms 206.

The client 300 and the server 320 may communicate directly or over a network, and may communicate via wired and/or wireless connections or any other method of communication.

The help application 324 may be operated in association with a text processing application, a graphics application, a spreadsheet application, a manual application of a mobile computing device including a mobile telephone, a banking application, an entertainment application, or any other application. The help application 324 may be operated independently from an associated service application or may be formed as an integral part of any one of the above service applications. Alternatively, the data processing system may include any other information providing application, such as a knowledge database or may provide access to the World Wide Web.

As an example, the help application 324 may be implemented using a known and commercially available help application for StarOffice™, a product of Sun Microsystems, Inc., and related products such as Sun One Webtop and OpenOffice.org. The help application may be included as a library for the help preprocessor 318. The help preprocessor 318 maybe integrated into the StarOffice™ environment, for example, by using known and available APIs. Documentation regarding APIs for StarOffice™ are available for download from http://api.openoffice.org. More specifically, documentation regarding the Help Content Provider is available at http://ucb.openoffice.org/docs/ucp-ref/help-ucp.html. The help system may also be included as a web based application in Sun One Webtop.

Additionally, the thesauruses 350 and 352 may be implemented by using a known and commercially available product named CorrectSpell®, available from Lernout & Hauspie Speech Products in Belgium. The thesauruses 350 and 352 may be maintained as a StarOffice™ library, and documentation on APIs for use in conjunction with StarOffice™ is available at http://api.openoffice.org. More specifically, information is available at

http:api.openoffice.org/servlets/ProjectDownloadList?action=download&dlID=67 and

at http://api.openoffice.org/5.2/reference/com/sun/star/linguistic/Thesaurus.html.

The search request may be received via any kind of communication with a user or user agent. For example, the search request may be input directly through a keyboard or transmitted from a remote user device, such as the client 300, to the server 320, including computer networks.

If the thesauruses or index devices 350 and 352 are located remotely from the server 320, a communication via communication networks may be chosen, including packet switched communication networks. The help preprocessor 318 may communicate with the client 300 and a thesaurus or index device 350 through any communication protocol, including known and yet to be developed communication protocols.

The help preprocessor 318 may perform a selection of at least one thesaurus or index device 350 or 352 based on a language indicator specified by the user, either in the search request, or as obtained from a user profile or from any other source. For example, the thesaurus or index device 350 or 352 may be available in different languages including different language dialects and the language indicator may specify one of those languages. Thus, the language indicator may specify one of English, German, Italian, or one of different language dialects, such as U.S. English, Australian English and other dialects.

The selection of the thesaurus or index device 350 or 352 may be based on any other consideration, for example, requests can be evenly distributed onto the thesaurus or index device 350 and 352. To facilitate the selection of a thesaurus or index device 350 or 352, a list of thesauruses or index devices and associated languages, including language dialects, may be accessible from the help preprocessor 318. Thus, the selection operation may be performed by obtaining the language indicator and searching in the list of thesauruses or index devices for thesaurus or index device 350 or 352 associated with the language corresponding to the language indicator. Alternatively, a selection of the thesaurus or index device 350 or 352 may be performed by polling the number of available thesauruses or index devices to obtain information whether a language including dialects corresponding to the language indicator is supported by the respective thesauruses or index devices 350 or 352.

After receiving a list of related terms or synonyms associated with the search term from the client 300, the help application 324 may generate a selection index based on the search term or character string and additional terms or character strings of the list of related terms or synonyms. The generation of the selection index may be accomplished via a keyword search or any other search technique (e.g., in a database of available information elements). A database of available information elements may be included in the server 320 or at one or a plurality of remote locations. Alternatively, the help application 324 may generate a selection index based on a search operation in a computer network such as the Internet, and retrieve information on desired information from the World Wide Web. Additionally, the selection index may be generated based on a search in a collection of keywords associated with information elements accessible by a search device.

The help application 324 may also forward the list of related terms or synonyms to further elements (not shown), which then generate a selection index including identifiers of information elements associated with the requested information.

The help application 324 may generate the selection index by performing a keyword search based on the list of related terms or synonyms and/or the search term or character string. If the list retrieved from the thesaurus or index device 350 or 352 is void, for example, if no terms or synonyms are available related to the search term or string included in the search request, the keyword search or any other technique for generating the selection index may be performed based solely on the search term from the user request.

As described above, the language indicator may specify a preferred language of a user or user agent. The language indicator may be retrieved from a user profile, or may be determined as a result of a user prompt to enter a language selection either online or offline. The language indicator may also be set at an arbitrary point in time. The user language may be a preferred language of the user, such as French, including any dialects, such as US English or Australian English, or any other language which is preferred by the user or user agent for performing the method of the present example. The thesaurus or index device 350 or 352 selected, for example, by the help preprocessor 318 may thus be a thesaurus or index device 350 or 352 maintaining a large number of indicators of related terms in a language corresponding to a preferred language of the user or user agent.

The help preprocessor 318 may select at least one second thesaurus or index device 350 or 352 in a language different from the preferred language to potentially enlarge the selection index. This may be a thesaurus or index device 350 or 352 associated with a language corresponding to a further language specified by the user or user agent or user request at least one second preferred language, or may be a thesaurus or index device 350 or 352 in a language selected based on other considerations. These other considerations may include selecting a thesaurus or index device 350 or 352 including a particularly large database of related terms or synonyms or may include selecting a thesaurus or index device 350 or 352 associated with a language which is widely spoken, such as English, or a language which is widely spoken in a particular region of the world, such as Spanish in Middle and South America. The request may then be transmitted to all of the selected thesauruses or index devices 350 and 352, for example, through the help preprocessor 318. In a multilingual application, the help preprocessor 318 may select all available thesauruses or index devices 350 and 352 for a maximum search result.

Additionally, thesauruses or index devices 350 or 352 available in dialects of a selected language may be selected. For example, if a language indicator indicates Bolivean Spanish, then at least one other thesaurus or index device 350 or 352 associated with other dialects (e.g., Chilean Spanish, Argentinean Spanish, Columbian Spanish, Ecuadorian Spanish, and Venezuelan Spanish) may be selected as well.

The selection process may be implemented as a user option, for example, an instruction to also use dialects for serving a search request. The option may be specified beforehand, (e.g., off-line), or the user or user agent could be prompted during service of a search request, for example, if the number of hits is low or terms returned are too similar to satisfy the user's needs.

The help preprocessor 318 may generate an initial, or preliminary index of search terms or strings based on the first term or character string from the user request, the initial or preliminary index including at least one third term or character string associated with the requested information to potentially enlarge the selection index. Thus, before transmitting the index request to a thesaurus or index device 350 or 352, an initial, or preliminary index may be generated including an already enhanced list of terms or character strings associated with the requested information.

The initial, or preliminary index may be generated by performing any search operation including a keyword search as described above with regard to generating the selection index. Generating the selection index and the initial or preliminary index may be accomplished using a common method (i.e., the same method), thus avoiding an increase of complexity of the information service application. Further, the help preprocessor 318 may include a plurality of language specific index tables for generating the selection index, and generating the preliminary index may include selecting a first index table in a language specified by the indicator of the language. Thus, generating the preliminary index may make use of existing system resources such as index tables maintained at the server 320 with keywords in particular languages. Moreover, the help preprocessor 318 may select at least one second index table in a language different from the language specified by the language indicator, similar to the previously described selection of the index device in a language different from the language associated with the language indicator. Alternatively, the language may be a further language input by the user or user agent, or obtained by other techniques, as described above.

The selection index generated by the help application 324 may include identifiers of information elements storing the actual information to be presented to the user or user agent (e.g., a name or descriptor), and may include links to storage locations storing the associated information elements. The links may be URLs or any other type of link. Thus, a clear and concise selection index is presented to a user, who, upon browsing through the selection index, selects one or more of the presented identifiers of information elements. The selection may be performed by “clicking” on a particular identifier, or by any other technique for specifying a desired information element.

The thesauruses or index devices 350 or 352, as previously discussed, may be implemented as separate entities connected to the server 320, or may be integrated with the server 320 into a single computing device.

The thesauruses or index devices 350 or 352 may include collections or databases of related terms or synonyms for search terms and may allow the retrieval of a list of related terms or synonyms in response to a received term or character string. For example, the thesauruses or index devices 350 or 352 may be databases of related terms or thesauruses available in many applications such as text processing applications, graphics applications, entertainment applications or spread sheet applications, or any other information processing applications providing, for example, related terminology or spell checking capabilities. A database of related terms or a thesaurus may include a large number of related terms or synonyms and/or cross-references associated with a particular search term. The thesauruses or index devices 350 or 352 may be organized as databases including links between individual interrelated terms or may be maintained as index files in one or more storage devices.

The thesauruses or index devices 350 or 352 may be maintained in a particular language (e.g., in the English language, German language or any other language). A thesaurus or index device 350 or 352 may also maintain terms in related languages.

While FIG. 3 indicates a plurality of individual thesauruses or index devices 350 or 352, the thesauruses or index devices 350 or 352 may be integrated into a single device (e.g., a single memory), being partitioned into regions storing terms of the respective index devices. Further, the thesauruses or index devices 350 or 352 may include intelligence to receive an index request from the help preprocessor 318 and to perform a search for related terms or synonyms regarding a received term or character string and to return the search result as a list of related terms or synonyms to the help preprocessor 318.

The client 300 may include a device allowing interaction with a user or user agent, for example, a keyboard or any other input device, or input logic for receiving a search request from the user or user agent and may utilize any technique to present a selection index to a user after performing the operations according to the present example. The client 300 may be integrated into a single unit with the server 320 or may be implemented as a separate device, such as a general purpose remote data processing device, including a personal computer, a laptop computer, a personal data organizer, a digital camera, a special purpose computer, or a mobile communication device. Even though only one client 300 is shown, it is understood that a plurality of user devices or users or user agents may access the server 320.

It is noted that the above elements of the system, including the help preprocessor 318, the thesauruses or index devices 350 or 352, and the client 300 may be at least partially realized as software and/or hardware. Further, it is noted that a computer-readable medium may be provided having a program embodied thereon, where the program is to cause a computer or system of data processing devices execute functions or operations of the features and elements of the above described examples described above. A computer-readable medium may be a magnetic or optical or other tangible medium on which a program is embodied, and may also be a signal (e.g., analog or digital), electromagnetic or optical, in which the program is embodied for transmission. Further, a computer program product may be provided including the computer-readable medium.

Exemplary systems suitable for practicing methods and implementing systems consistent with the present invention may include networked, or otherwise interconnected systems, each having a structure similar to that shown in FIG. 3.

The present example enables the generation of a potentially enhanced, or enlarged, or broader selection index in response to a search request. As discussed previously, conventional techniques have simply used a character string provided in a user request as a sole basis for building a selection index. However, as a single term or character string may describe desired information very specifically or narrowly, the search result may be unacceptable (e.g., the selection index may include only a few information elements which do not satisfy a user's needs). In contrast, the present exemplary embodiment uses the search term and related terms or character strings provided by at least one thesaurus or index device as a basis for building the selection index. The related terms or character strings may describe different aspects of the desired information or may describe similar topics. Thus, the search request draws on a larger or enhanced base and the selection index will potentially include a larger number of hits (e.g., information elements). Thus, a search request from a user may be enhanced to obtain a potentially enlarged or enhanced selection index.

More specifically, as help preprocessor 318 obtains additional terms or character strings (e.g., synonyms) related to the search term, i.e. the search term included in the search request from the user, the operation of generating the selection index (e.g., a keyword search in a database) can be improved to achieve a larger number of hits resulting in the enlarged or enhanced selection index. The additional terms or character strings and the first term can then be processed by the help application 324, for example, in a keyword search which includes a Boolean OR command or any other search combination.

Although aspects of the present invention are depicted as being stored in memory 306 and memory 322, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. Further, although specific components of the client 300 and the server 320 are described, one skilled in the art will appreciate that a computer system suitable for use with methods, systems, and articles of manufacture consistent with the present invention may contain additional or different components.

The data processing system shown in FIG. 3 may include elements of a data processing device, partially realized in hardware and/or software. Further, the data processing system, may form part of any data processing device such as a general purpose data processing device, a special purpose computing device, a personal or laptop computer, a personal organizer device, a digital camera or a communication device including a mobile communication device such as a cellular or any other mobile telephone.

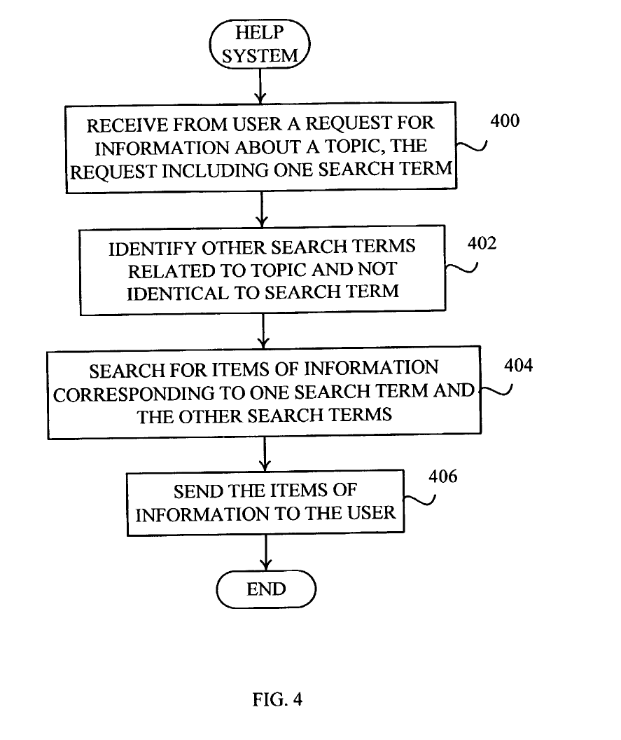

FIG. 4 depicts a flowchart of the steps performed by a help system according to an exemplary embodiment consistent with the present invention. After starting, in step 400, the help system receives from the user a request for information about a topic, the request including a search term. The user may include a user similar to the client 300 discussed previously with regard to FIG. 3, and the search term may include a search term similar to the term 100 discussed previously with regard to FIGS. 2a-2b.

In step 402, the help system identifies other search terms related to the topic and not identical to the search term. The other search terms may include the other search terms similar to the synonyms 206 discussed previously with regard to FIGS. 2a-2b. In step 404, the help system searches for items of information corresponding to the original search term and the other search terms. In step 406, the help system sends the items of information to the user. The items of information may include items of information similar to the information elements of the selection index 210 discussed previously with regard to FIGS. 2a-2b.

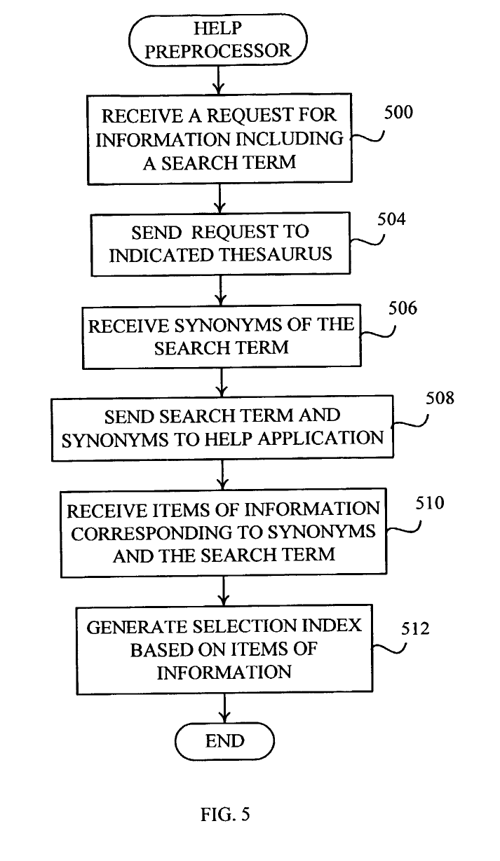

FIG. 5 depicts a flowchart of the steps performed by the help preprocessor 318 for providing an information service according to an exemplary embodiment consistent with the present invention. After starting, in step 500, the help preprocessor receives a request for information including a search term. The search term may correspond to the search term 100 discussed previously with regard to FIGS. 2a-2b.

In step 504, the help preprocessor 318 sends the request to the thesaurus indicated by a language indicator received with the request. Step 504 is described in greater detail below. In step 506, the preprocessor receives synonyms of the search term. The synonyms may include synonyms similar to the synonyms 206 discussed previously with regard to FIGS. 2a-2b. In step 508, the preprocessor sends the search term and the synonyms to the help application 324. In step 510, the preprocessor 318 receives items of information corresponding to the synonyms and the search term. The items of information may include items of information similar to the items of information discussed previously with regard to the information elements of the selection index 210 of FIGS. 2a-2b. In step 512, the preprocessor generates a selection index based on the items of information received at step 510.

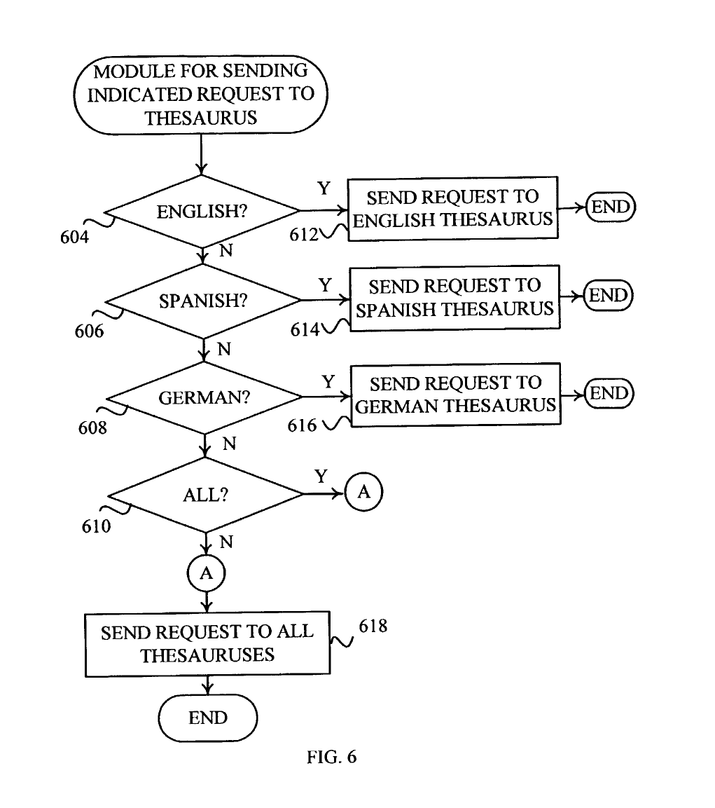

FIG. 6 depicts a flowchart of the steps performed by a module for determining, and sending a request to, a thesaurus for providing multilingual help according to an exemplary embodiment consistent with the present invention. These steps describe in greater detail steps performed as part of step 504 of FIG. 5 as described above. After starting, in step 604, the module determines whether the language indicator indicates the English language. If, in step 604 it is determined that the language indicator indicates the English language, then in step 612, the module sends the request to an English language thesaurus.

If, in step 604, the module determines that the language indicator does not indicate the English language, then in step 606, the module determines whether the language indicator indicates the Spanish language. If, in step 606, the module determines that the language indicator indicates the Spanish language, then in step 614, the module sends the request to a Spanish language thesaurus.

If, in step 606, the module determines that the language indicator does not indicate the Spanish language, then, in step 608, the module determines whether the language indicator indicates the German language. If, in step 608, the module determines that the language indicator indicates the German language, then in step 616, the module sends the request to a German language thesaurus.

If, in step 608, the module determines that the language indicator does not indicate the German language, then in step 610, the module determines whether the language indicator indicates all languages. If, in step 610, the module determines that the language indicator indicates all languages, then, in step 618, the module sends the request to all thesauruses. If no value is provided for the language indicator, the default may be to send the request to all thesauruses.

Use of a language indicator for indicating at least one thesaurus or index device enables a user to request information, for example, in a multilingual help system or information providing system using a plurality of available index devices or thesaurus databases. For example, the thesaurus or index device may be selected based on the language indicator (e.g., a preferred language obtained from a user profile or input by a user or user agent). Thereafter, at least one second thesaurus or index device may be selected in a language different from the preferred language as specified by the language indicator. This may be a second preferred language as specified by the user or user agent. At least one second preferred language may be specified by a user or user agent, e.g., upon being prompted by the system to input a further language for the search, for example, if only a few search results are obtained based on the preferred language.

Further, at least one second preferred language could be obtained from a user profile, which may be specified beforehand by the user or user agent, or a system administrator. Moreover, selection options may be provided allowing a user or user agent to select a number of further languages for the search (e.g., in dependence on a number of search results in the selection index obtained in a previous search operation). Additionally, in a multilingual mode, all available thesauruses or index devices 350 and 352 may be selected.

Alternatively, the request with the search term may be first transmitted to the first thesaurus or index device corresponding to the preferred language specified by the language indicator, and a list of related terms or synonyms may be obtained from the first index device. Thereafter, based on some or all of the terms included in the list of terms received from the first thesaurus or index device corresponding to the preferred language, a request may be generated and transmitted to at least one second index device. Thus, the request transmitted to the at least one second thesaurus or index device may already include a number of related terms or synonyms retrieved in the first selection operation involving the first thesaurus or index device. This example may further enlarge the search base, by including thesauruses or index devices corresponding to different languages. To exploit the capability of this example, a user may specify search strings associated with the desired information in a plurality of languages, preferably in the languages of the thesauruses or index devices to be selected.

Alternatively, a preliminary selection index may be generated to further enlarge a number of search results obtained with the selection index. As an example, if a user decides that a number of desired items of a selection index, for example, in a help application or any other information providing application should be further enlarged, or, if it is found that a previous selection index contains an unacceptably small number of information elements, an initial, or preliminary selection index may be generated at the help preprocessor 318 before transmitting the terms of this selection index to at least one selected thesaurus or index device. Thus, an initial or preliminary index based on the search term or character string may be generated, including at least one additional term or character string associated with the requested information. A corresponding request associated with the initial or preliminary index may then be transmitted to selected thesauruses or index devices.

Accordingly, the help preprocessor 318 may include a plurality of language specific index tables for generating the selection index, and generating the initial or preliminary index may include selecting a first index table in a language specified by the language indicator. Generating the initial or preliminary index may include selecting at least one second index table in a language different from the language specified by the language indicator. Therefore, in order to further increase a number of elements of the selection index, an initial or preliminary index may be generated by the help preprocessor 318 as described above.

For this example, generating the initial or preliminary index, for example, at the help processor 318 and/or help application 324 may be performed using the same method as when building a selection index. Thereafter, a request including an indication of the first and/or at least one additional term or character string is transmitted to the selected thesaurus or index device 350 or 352, i.e., all search terms or strings obtained at the help preprocessor 318 are transmitted to the selected thesaurus or index device 350 or 352 in order to perform a search for related terms or synonyms at the thesaurus or index device 350 or 352.

Alternatively, this example may be combined with the previous example described, i.e., this example may be used in a multilingual environment, wherein a plurality of thesauruses or index devices in a plurality of different languages may be employed.

As a further example, a user or user agent may input desired languages for performing the search operations. For example, the user or user agent may be prompted to input information regarding a user language by specifying a list of at least one preferred language. This list of languages may be ordered according to preference, i.e. a most preferred language could be placed at a first position in the list of languages. The operation for inputting a language indicator may be performed at an arbitrary point in time, for example during a system set-up or during a log-on operation. Further, the language indicator may be input interactively during execution of the method or application in which the user or user agent generates the request for information, for example, the language indicator may be entered through a pop-up window or selection box presented to the user during execution of the application. This operation may include a selection of languages available on the system, for example, languages of thesauruses or index devices accessible by the help preprocessor 318. Using a list of at least one preferred language, the initial or preliminary index and/or the selection index can be generated, as described above. This example provides a user or user agent further flexibility in selecting preferred languages in order to further increase a number of possible hits, e.g., when searching for information.

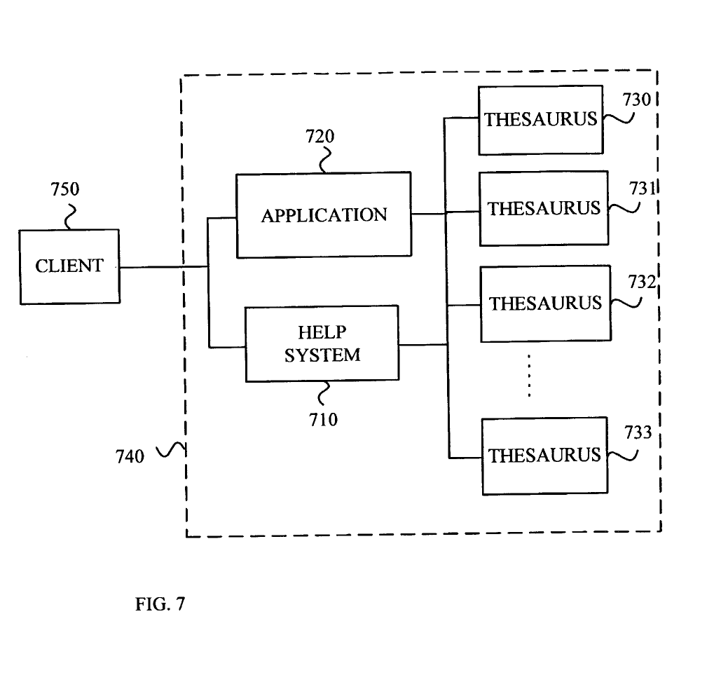

FIG. 7 is a block diagram of an exemplary system for providing an information service illustrating joint use of thesauruses by an application and a help system. The system includes, for example, a help system 710, for building a selection index based on a list of related terms or synonyms, as described above. An application 720, for example, executes a service application under control of a user or user agent. The application 720 may execute a text processing application, graphics application, entertainment application, spreadsheet application, or any other kind of service application including, for example, a manual application of a communication device. The application 720 and the help system 710 both communicate, either directly or indirectly, with thesauruses, or index devices 730, 731, 732 and 733, which may include thesauruses or index devices associated with different languages, as described above. The help system 710, the application 720 and the thesauruses or index devices 730, 731, 732 and 733 may be integrated in a single unit 740, such as a server. However, these elements may also be realized as individual elements connected through communication links, including communication networks (i.e., these elements may be located at virtually arbitrary locations).

A client 750 (e.g. a client computing device such as a personal computer, a laptop computer, a mobile telephone, a digital camera, a special purpose computer, a personal organizer or any other communication device) communicates with the server 740. The client 750 may be in communication with the server 740 through a dedicated communication link or a communication network, such as a local area network or the Internet. Even though only a single client 750 is shown, it is understood that a plurality of client devices operated by a plurality of clients may be present and accessing the server 740.

The application 720, as described above, may be implemented as a multilingual service application, including a plurality of thesauruses or index devices 730, 731, 732, and 733 associated with individual languages. This may be, for example, implemented in text processing applications, graphics applications, etc., as described above.

The help system 710, implemented as either a stand-alone application or as integrated into the application 720, may be enabled to access the thesauruses or index devices 730, 731, 732, and 733, for obtaining a potentially enlarged base for information retrieval, as described above.

The application 720, which may be controlled by a user or user agent operating the client 750, and the help system 710, which may also be controlled by the client 750, may both access the thesauruses or index devices 730, 731, 732, and 733 for their own purposes. Thus, for the help system 710, the thesaurus, or index device 730 may generate a list of synonyms or related terms, while for the application 720, it may be utilized to perform a spell-check operation. Alternatively, a plurality of applications 720 may access the thesauruses or index devices 730, 731, 732, and 733, and a plurality of help systems 710 may access the thesauruses or index devices 730, 731, 732, and 733.

Thus, the example shown in FIG. 7 provides further flexibility and allows a shared use of system resources, by shared use of the thesauruses or index devices 730, 731, 732, and 733. The example shown in FIG. 7 is well suited for an application in a communications network, such as the Internet and/or a local area network serving a potentially very large number of users. For example, a plurality of users or user agents may obtain services from the application 720 (e.g. remote text, graphics or spreadsheet processing services).

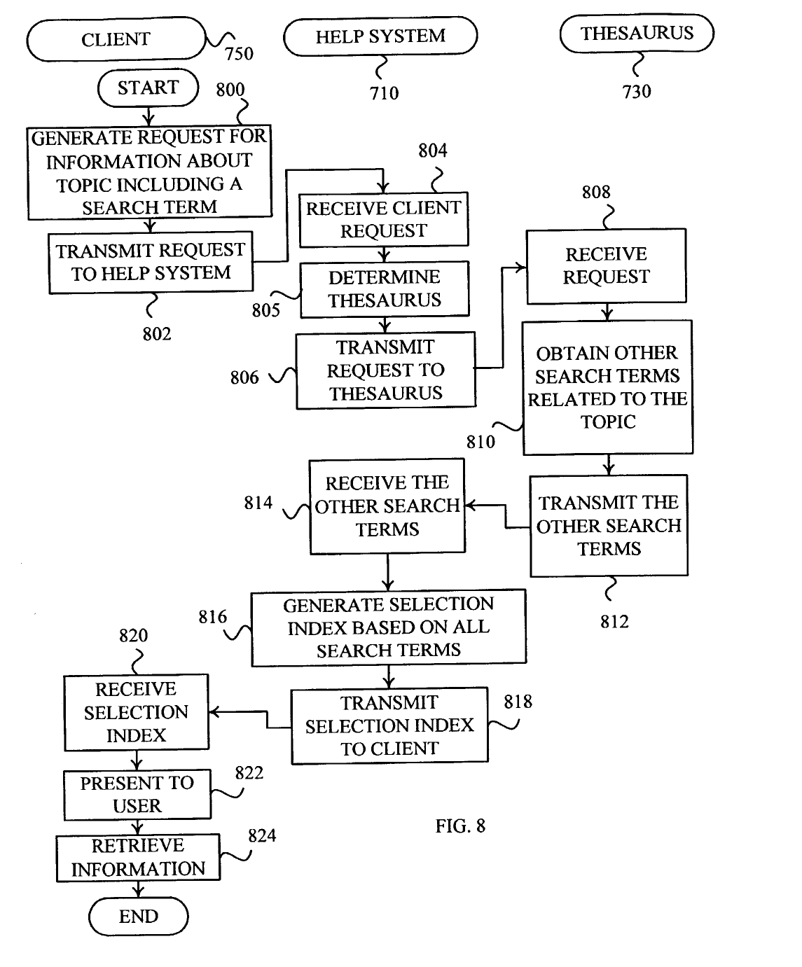

FIG. 8 is a flowchart of the steps performed by a system for providing help information according to an exemplary embodiment consistent with the present invention. As an example, using the system of FIG. 7, in step 800 of FIG. 8, the client 750 generates a request for information about a topic including a search term. As indicated, the request may be generated at the client 750, the request including at least one term or character string associated with requested information. If a plurality of terms or character strings is provided in the request, they may be connected by Boolean operators (e.g., an OR operator). In step 802, the client 802 transmits the request to the help system 710. The transmission may involve any kind of communication network or communication link as described above. In step 804, the help system 710 receives the client request. A language indicator may be retrieved from a user profile or, alternatively, a user or user agent may be prompted to input a language parameter, as described above. Based on the language indicator, in step 805, the help system 710 determines a thesaurus or index device 730, 731, 732, or 733, as described above. This operation may involve selecting a single thesaurus or index device based on the language indicator, or may involve selecting a plurality-of thesauruses or devices based on multiple languages of the language indicator. Alternatively, in a multilingual mode, all available thesauruses or index devices 730, 731, 732, and 733 may be selected.

In step 806, the help system 710 transmits a request to the thesaurus or index device 730, 731, 732 or 733. A request including an indication of the first term or character string is transmitted to the selected thesaurus or index device 730, 731, 732, or 733, i.e., a single thesaurus or index device or the plurality of selected thesauruses or index devices. The thesaurus or index device 730, at step 808, receives the request, and, at step 810 obtains other search terms related to the topic. This may, as described above, be a related term or synonym of the search term or character string of the original user request, obtained as described above.

In step 812, the thesaurus 730 transmits the other search terms to the help system 710. The other search terms may be transmitted, for example, as a list of related terms or synonyms. Transmissions between the help system 710 and the thesaurus or index device 730, 731, 732, or 733 may be via dedicated communication links or network communications including packet switched connections or any other communication technique. In step 814, the help system 710 receives the other search terms.

In step 816, the help system 710 generates the selection index based on all search terms, and in step 818, the help system 710 transmits the selection index to the client 750, as described above. In step 820, the client 750 receives the selection index 750 and in step 822, the client 750 presents the selection index to the user. This may involve presenting the selection index on a display (e.g., as a list of identifiers associated with information elements of the selection index).

In step 824, the client 750 retrieves information. For example, the user may select at least one of the presented information elements of the selection index and retrieve associated information. This may involve retrieving the information from the server 740, or from any other location, for example, in a computer network such as the Internet or a local area network.

The above example shows that the application is well suited for network based implementation, such as in a system for providing a remote processing server for users.

It is noted that the above elements of the above examples may be at least partially realized as software and/or hardware. Further, it is noted that a computer-readable medium may be provided having a program embodied thereon, where the program is to make a computer or system of data processing devices execute functions or operations of the features and elements of the above described examples. A computer-readable medium may include a magnetic or optical or other tangible medium on which a program is embodied, but can also be a signal, (e.g., analog or digital), electromagnetic or optical, in which the program is embodied for transmission. Further, a computer program product may be provided comprising the computer-readable medium.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in a data processing system having a preprocessor, a help application, and a plurality of thesauruses, the method comprising the steps of:
receiving, by the preprocessor, a request for information about a topic, the request containing a search term and a language indicator;
determining which one of the plurality of thesauruses is suitable for the indicated language;
sending the request to the determined thesaurus;
receiving synonyms of the search term from the determined thesaurus;
sending the search term and the synonyms to the help application; and
receiving items of information corresponding to the synonyms and the search term.

2. The method of claim 1, wherein the determined thesaurus includes at least one related term related to the search term.

3. The method of claim 1, further comprising the step of generating a selection index.

4. The method of claim 3, wherein the step of generating the selection index further includes the step of performing a keyword search based on the search term and the synonyms of the search term.

5. The method of claim 3, wherein the selection index includes at least one reference to a storage location which includes the requested information.

6. The method of claim 1, wherein the language indicator is obtained from a profile of a user.

7. The method of claim 1, wherein the language indicator indicates at least two different languages.

8. The method of claim 1, wherein the determined thesaurus is associated with a predetermined language and dialect.

9. The method of claim 1, wherein the request for information is associated with a service application.

10. The method of claim 9, wherein the service application includes at least one of
a text processing application,
a graphics application,
a database application,
an entertainment application, and
a spreadsheet application.

11. A method in a data processing system having a help system with search terms and corresponding items of information, the method comprising the steps of:
receiving a request for information about a topic, the request containing one of the search terms;
identifying other search terms that are related to the topic and that are not identical to the one search term;
searching for items of information corresponding to the one search term and the other search terms; and
returning the items of information.

12. The method of claim 11, wherein the step of receiving the first request for information further comprises receiving, from the user, the request for information about a topic, the request containing one of the search terms.

13. The method of claim 12, wherein the step of returning the items of information further comprises returning the items of information to the user.

14. The method of claim 11, wherein the step of receiving the first request for information further comprises receiving, by a help preprocessor, the request for information about the topic, the request containing one of the search terms.

15. The method of claim 11, wherein the step of identifying other search terms further comprises sending the request to one of a thesaurus and a database of related terms.

16. The method of claim 11, wherein the step of searching for items of information further comprises sending a list of synonyms of the one search term to a help application.

17. The method of claim 16, further comprising the step of receiving, from the help application, a selection index including at least one information element.

18. The method of claim 11, further comprising the step of generating a preliminary search index based on the one search term.

19. A computer-readable medium encoded with instructions that cause a data processing system, the data processing system having a help system with search terms and corresponding items of information, to perform a method comprising the steps of:
receiving a request for information about a topic, the request containing one of the search terms;
identifying other search terms that are related to the topic and that are not identical to the one search term;
searching for items of information corresponding to the one search term and the other search terms; and
returning the items of information.

20. The computer-readable medium of claim 19, wherein the step of receiving the request for information further comprises receiving, by a help preprocessor, the request for information about the topic, the request containing one of the search terms.

21. The computer-readable medium of claim 19, wherein the step of identifying other search terms further comprises sending the request to one of a thesaurus and a database of related terms.

22. The computer-readable medium of claim 19, wherein the step of searching for items of information further comprises sending a list of synonyms of the one search term to a help application.

23. The computer-readable medium of claim 19, wherein the method further includes the step of receiving, from a help application, a selection index including at least one information element.

24. The computer-readable medium of claim 19, wherein the method further includes the step of generating a preliminary search index based on the one search term.

25. A data processing system for obtaining items of information corresponding to search terms, the system comprising:
a memory comprising a help system that receives a request for information about a topic, the request containing one of the search terms, identifies other search terms that are related to the topic and that are not identical to the one search term, searches for items of information corresponding to the one search term and the other search terms, and returns the items of information to the user; and
a processor for running the help system.

26. The data processing system of claim 25, wherein the help system identifies the other search terms by sending the request to one of a thesaurus and a database of related terms.

27. The data processing system of claim 25, wherein the help system searches for items of information by sending a list of synonyms of the one search term to a help application.

28. The data processing system of claim 25, wherein the help system generates a selection index including at least one information element.

29. The data processing system of claim 25, wherein the help system generates a preliminary search index based on the one search term.

30. A data processing system for obtaining items of information corresponding to search terms, the system comprising:
means for receiving a request for information about a topic, the request containing one of the search terms;
means for identifying other search terms that are related to the topic and that are not identical to the one search term;
means for identifying items of information corresponding to the one search term and the other search terms; and
means for sending the items of information to the user.

31. The data processing system of claim 30, wherein the means for receiving the request for information includes a help preprocessor.

32. The data processing system of claim 30, wherein the means for identifying other search terms includes at least one of a thesaurus and a database of related terms.

33. The data processing system of claim 30, wherein the means for searching for items of information includes a help application.
